(19) United States
(12) Patent Application Publication
(10) Pub. No.: US 2016/0035460 A1
(43) Pub. Date: Feb. 4, 2016

(54) ANTI-TWIST CABLE

(71) Applicant: Aetna Insulated Wire LLC, Virginia Beach, VA (US)

(72) Inventors: Richard Williamson, Norfolk, VA (US); Howard Jackson, Virginia Beach, VA (US)

(21) Appl. No.: 14/813,899

(22) Filed: Jul. 30, 2015

Related U.S. Application Data
(60) Provisional application No. 62/030,657, filed on Jul. 30, 2014.

(51) Int. Cl. H01B 7/40; H01B 3/30; H01B 9/00; H01B 3/44

(52) U.S. Cl. CPC H01B 7/40; H01B 3/445; H01B 3/305; H01B 3/30; H01B 9/005; H01B 9/003

(57) ABSTRACT

A cable includes a cabled core including conductors and tensile members. The conductors have a first lay direction. An anti-twist wrap is applied over the cabled core with a second lay direction opposite the first lay direction of the cabled core. An extruded-to-fill jacket is extruded over the cabled core to lock the anti-twist wrap in place and to protect the cabled core.

### CROSS REFERENCE TO RELATED APPLICATIONS

This application claims priority to U.S. Provisional Patent Application No. 62/030,657, filed Jul. 30, 2014, the entire contents of which are hereby incorporated by reference.

### FIELD OF THE INVENTION

The present invention relates generally to electrical, electronic or communication cables and, in particular, to an anti-twist concept for the support of long length, vertically installed electrical, electronic or communication cable using integral tensile members.

### BRIEF DESCRIPTION OF THE DRAWINGS

FIG. 1 is a perspective sectional view of an embodiment of the anti-twist cable of the present invention.

### DETAILED DESCRIPTION OF EMBODIMENTS

From time to time, it is necessary to install cables in a vertical application where the length of the cable being installed, the cable construction or the physical circumstances of the installation require that the cable include dedicated construction members for either temporarily or permanently supporting the cable length. Historically the cable weight has been supported by a number of different techniques including:

a) steel wire armor helically applied to the cable and used to support the weight;

b) messenger wire lashed to the cable for supporting the weight; and/or

c) the use of high tensile strength members integrated into the design of the cable core and the core covered with a layer of interlocking steel or aluminum armor. The cable is constructed so that the armor “locks” the components in place by restricting radial movement and an untwisting of the core.

As greater and greater depths are addressed, and cables get longer and longer, the weight of the steel armor makes it necessary to use larger and heavier steel tensile members to carry the cable weight. Furthermore, the diameter buildup of the interlocking armor makes it difficult to fit the cable on a reel small enough to get into position to payoff cable to the installation.

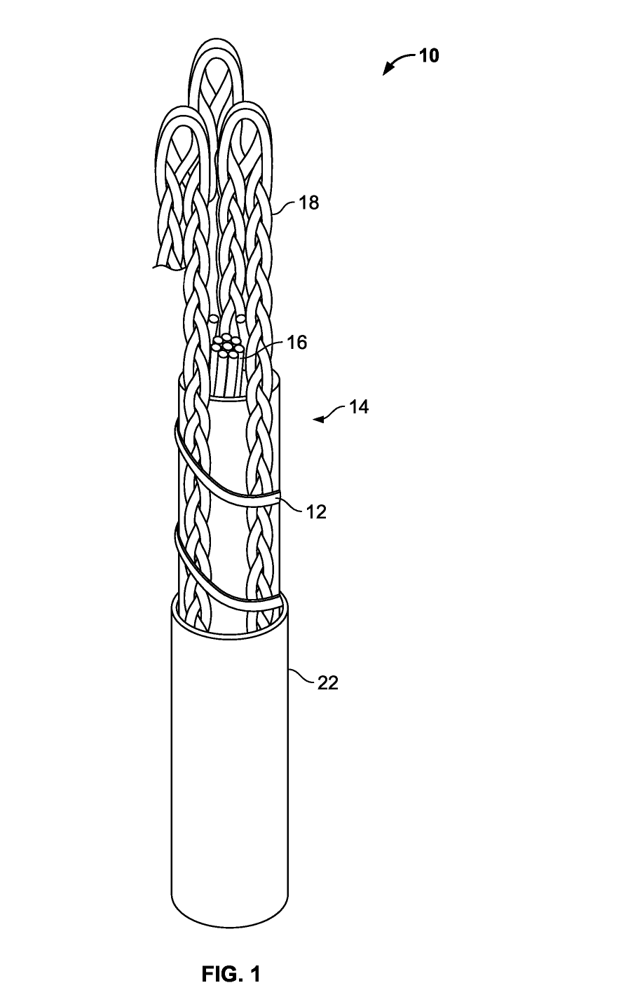

An embodiment of the cable of the present invention is indicated in general at 10 in FIG. 1. The cable has been redesigned to eliminate the heavy armor layer and its associated outer jacket. This approach reduces the outer diameter of the cable and reduces the total weight of the cable. Problematical to removing the armor, however, is that there is no layer to radially restrict movement of the cable components nor is there anything that prevents the cable from “untwisting.”

In order to address these problems a reverse wrap or anti-twist wrap, indicated at 12 in FIG. 1, is applied over the cabled core, indicated in general at 14, with a lay opposite to the lay of the conductors 16 and tensile members 18. The cabled core may include power, communication and/or data carriers or wires. As an example only, the conductors may be constructed from a metal such as copper or may be fiber optic cables. An “extruded-to-fill” jacket 22 is extruded over the complete core to lock the reverse wrap in place and protect the cable core.

As an example only, the jacket 22 may be constructed of a PVC or nylon composition.

The anti-twist wrap 12 may be constructed from any high strength, lightweight material, such as a polymer or plastic. The material is also preferably has a high heat capacity.

The tensile members 18 are preferably constructed of synthetic material, such as TECHNORA (which is a para-aramid fiber made from co-polymers) or DYNEEMA. In use, the tensile members 18 are attached to pulling equipment by the loops formed at the top of each tensile member. The cable may then be pulled up through a generally vertical passage. Once pulled up through the passage, the cable may be secured in position by fastening the loops to a stationary support at the top of the passage.

While the preferred embodiments of the invention have been shown and described, it will be apparent to those skilled in the art that changes and modifications may be made therein without departing from the spirit of the invention.

What is claimed is:

1. A cable comprising;
a) a cabled core including conductors having a first lay direction;
b) an anti-twist wrap applied over the cabled core with a second lay direction opposite the first lay direction of the cabled core.

2. The cable of claim 1 wherein the conductors include power wires.

3. The cable of claim 1 wherein the conductors include communication wires.

4. The cable of claim 1 wherein the conductors include data wires.

5. The cable of claim 1 wherein the cabled core includes tensile members.

6. The cable of claim 5 wherein the tensile members are made from a para-aramid fiber made from co-polymers.

7. The cable of claim 1 further comprising an extruded-to-fill jacket extruded over the cabled core to lock the anti-twist wrap in place and protect the cabled core.

8. The cable of claim 7 wherein the jacket includes polyvinylchloride.

9. The cable of claim 7 wherein the jacket includes nylon.

10. The cable of claim 1 wherein the anti-twist wrap is made from a polymer or plastic.

11. A cable comprising;
a) a cabled core including conductors and tensile members, said conductors having a first lay direction;
b) an anti-twist wrap applied over the cabled core with a second lay direction opposite the first lay direction of the cabled core; and
c) an extruded-to-fill jacket extruded over the cabled core to lock the anti-twist wrap in place and protect the cabled core.

12. The cable of claim 11 wherein the conductors include power wires.

13. The cable of claim 11 wherein the conductors include communication wires.

14. The cable of claim 11 wherein the conductors include data wires.

15. The cable of claim 11 wherein the conductors are constructed from metal.

16. The cable of claim 11 wherein the conductors include fiber optic cables.

17. The cable of claim 11 wherein the tensile members are made from a para-aramid fiber made from co-polymers.

18. The cable of claim 11 wherein the jacket includes polyvinylchloride.

19. The cable of claim 11 wherein the jacket includes nylon.

20. The cable of claim 11 wherein the anti-twist wrap is made from a polymer or plastic.
